(19) United States
(12) Patent Application Publication
(10) Pub. No.: US 2003/0060996 A1
(43) Pub. Date: Mar. 27, 2003

(54) Semi-automated multi-site system tester

(76) Inventors: John Yi, Austin, TX (US); Terry Marquis, Austin, TX (US); K.S. Chen, Singapore (SG); Zheng Zhu, Singapore (SG)

Correspondence Address: Winstead Sechrest & Minick P.C., 5400 Renaissance Tower, 1201 Elm Street, Dallas, TX, 75270-2199, US

(21) Appl. No.: 10/201,046

(22) Filed: Jul. 23, 2002

Related U.S. Application Data
(63) Continuation of application No. 09/589,599, filed on Jun. 7, 2000, now abandoned.

(51) Int. Cl. G01M 19/00; G06F 19/00

(52) U.S. Cl. 702/121

(57) ABSTRACT

A processor chip is tested by placing it on a modified system motherboard within a system test station The modified motherboard is able to operate as a fully functional PC motherboard with an operating system and application software. A socket is provided to allow the easy addition and removal of processor chips under test The test program for testing a processor chip is exercised as an application program and monitors and reports status of the test to the system test controller A thermal unit with a built in temperature controller is coupled to the system motherboard as via an I/O connector. At the start of a test the thermal unit is brought into contact with the processor chip under test and the thermal unit either heats or cools the processor chip to maintain the processor chip case at a required test temperature The stations operate in a semi-automatic mode with an operator needed only to insert and extract processor chips and indicate a test ready condition The number of test stations is limited only by the networking capability of the test system configured for a particular manufacturing environment.

### TECHNICAL FIELD

The present invention relates in general to a tester for testing a processor chip using the system board for a PC or a workstation.

### BACKGROUND INFORMATION

Personal computers (PCs) are high volume products that must be tested to determine that the entire system is operational before shipping to a customer A complete PC may have a variable number of system components depending on the configuration selected by a customer The processor chip used in the PC is one of the components that may undergo multiple test cycles as part of the system manufacture and assembly. PC systems are sold in a variety of performances with the highest performing systems usually the most expensive. While automated test equipment (ATE) systems are available to test the processor chip, the performance limits determined (voltage, frequency, temperature, etc.) may be different when the processor chip is in the test station of an ATE and from those obtained on a system motherboard. For this reason, even though a chip may pass, an ATE test program, the same chip may undergo a system level test where it is placed on a test motherboard for the test cycle. In this test environment, the processor chip may have specific parameters varied while it runs software programs (e.g., Windows 2000) in an environment like its end use environment.

To test all of the processor chips on a high volume manufacturing line in a product use environment requires a parallel test method where many parallel and manned stations verify the performance of all processor chips. Replicating single manned test stations is one way to improve the throughput of the system test for processor ICs. However, replicating many individual manned test stations is expensive and leads to problems associated with human error and logistics Since the volume of processor IC increases every year, there is a need for another approach to handle testing the high volume of processor chips in a system test environment

### SUMMARY OF THE INVENTION

A test methodology and system for processor chips in a system test environment which comprises a standardized test station that includes a system motherboard, a thermal unit, a storage unit and a network communication port The system motherboard is modified only to include a high insertion socket for the processor chip Control and test lines are coupled to the system motherboard for controlling the system test operation via standard I/O connectors. A thermal unit is provided that is thermally coupled to the processor chip at the start of a test and either heats or cools a processor chip under test to a desired case temperature while it is running system level software This embodiment allows normalization of the test process to a common processor chip temperature while other system parameters (e.g., voltage and frequency) may be uncontrolled by the test process The test station also has a standardized computer communication port so that multiple test stations may be networked and controlled from a central location. The test stations operate singly or in clusters as remote I/O devices where their function is to execute application software on a processor chip under test An executable test program monitors the processor chips operation for errors and communicates errors, processor chip case temperature data and test status to the system test controller A cluster of test stations, under command from the central controller, may be manned by a single operator who provides the function of extracting processor chips (tested and good or failed) or loading new processor chips into the test station. The test stations, with their standard network communication features, may be placed singly or in groups throughout a manufacturing floor.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a system test controller coupled via a network to test stations;

FIG. 2 illustrates a modified system motherboard with thermal unit according to embodiments of the present invention, and

FIG. 3 illustrates method steps used in embodiments of the present invention.

### DETAILED DESCRIPTION

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail For the most part, details may have been omitted in as much as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views

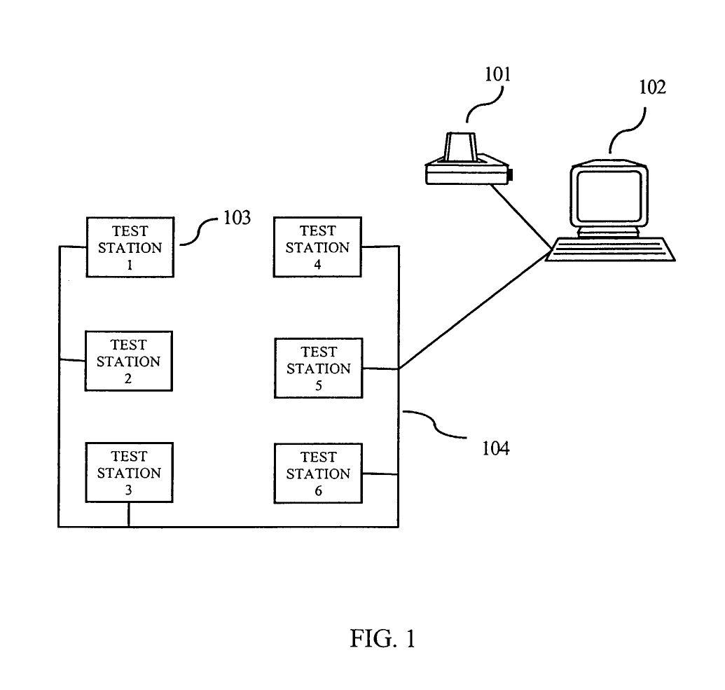

FIG. 1 illustrates a system test controller 102 with an output device 101 and coupled to a network 104 for linking a number of test stations (eg, 103) A multi-site system test station for processor chips is constructed where each test station 103 has the functionality of a system board operating the processor chip in a user environment. The system board is modified but fully functional as a PC system networked to a central test controller or system. The test station 103 comprises a modified motherboard that has all support devices so the processor chip is able to run applications under an operating system

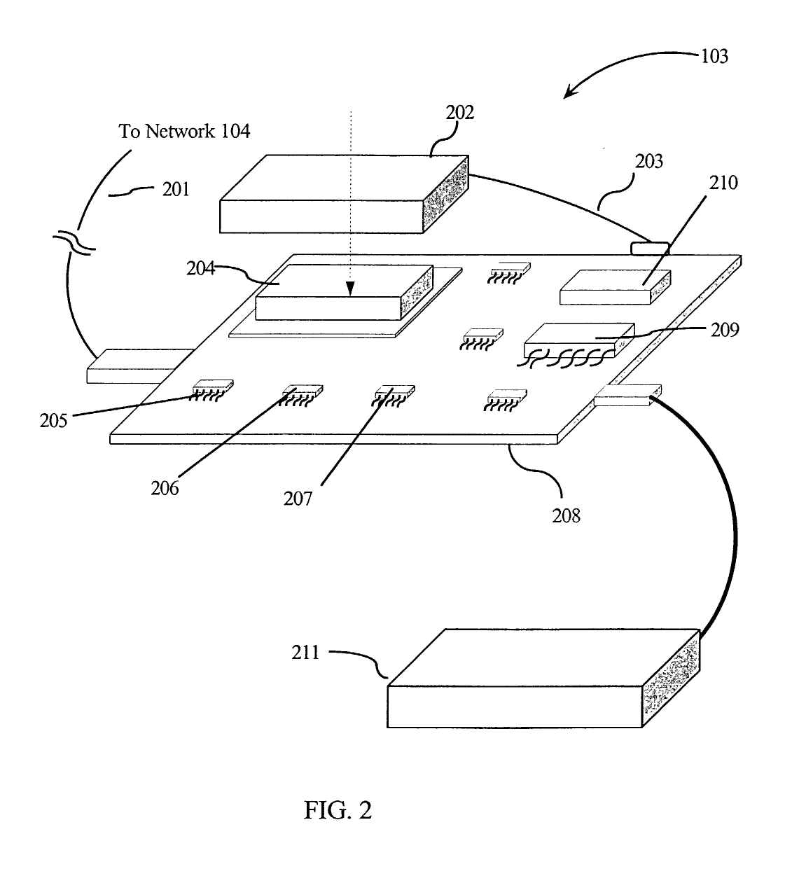

FIG. 2 illustrates a system motherboard 208 having a socketed processor chip 204 and support chips 205, 206, 207, and 209. An on motherboard memory 210 or an external storage device 211 coupled to the modified motherboard 208 may store the operating system and application programs Once a processor chip 204 has been inserted in the modified motherboard 208, the test controller 102 is notified that the test station 103 is ready Additionally the test station 103 is equipped with a thermal unit 202 that is thermally coupled to the processor chip 204 (not shown) and has the functionality to control the case temperature of the processor chip 204. Sensors in the thermal unit 202 may feedback temperature data (via 203) to the modified motherboard 208 and the system test controller 102. The test station 103 operates as a network device (coupled via 201 to network 104) and contains “driver” code that allows it to operate as a test station 103 while appearing like a remote system to the system controller 102 The test station 103 appears to have the functionality of a PC system in its ability to operate as a standard networked device running application programs under a PC operating system. While operating as a PC system, the test station 103 simultaneously maintains the functionality of a test station 103 in applying and controlling the temperature of a processor chip 204 and the sensing and reporting of failures to the system test controller 102. Because the test station 103 is self contained and interfaces to the system test controller 102 using standard network adaption, single or groups of test station 103 may be placed wherever necessary on the manufacturing floor. Manned operation is only necessary to load or extract processor chips and execute simple operator functions. The disposition of the chips is indicated by the system test controller 102 after analysis of the results of the software used in the test sequence. Tests can be started and stopped independently in each test station 103 and no synchronization of tests between test stations 103 is required The test stations 103 and the system test controller 102 operate in an interactive mode where the system test controller 102 is signaled as to the status of each test station 103.

The introduction of a new processor 204 into manufacturing requires only that a new modified processor motherboard 208 be assembled into existing test stations 103. Since the test station 103 operates on the processor motherboard network interface, the control of the test process remains the same Likewise, different modified processor motherboards 208 may be present in test stations 103 coupled to the same test controller 102. The thermal unit 202 for a specific processor may have to be relocated in the test station 103 and the system controller 102 may need to be notified of the particular test station's active application test software.

Embodiments of the present invention store the required application test software in the test station 103. Other embodiments of the present invention store all application test software in the system test controller 102 and the particular active test software for a particular test station 103 may only be loaded into a test station 103 when needed

In another embodiment of the present invention, the thermal unit 202 may be repositioned in the test station 103, by an operator or automatically, depending on the particular test motherboard in place. The control for the thermal unit 202 and the processor chip temperature monitoring is contained in and moves with the thermal unit 202 as it is placed in contact with the processor chip under test.

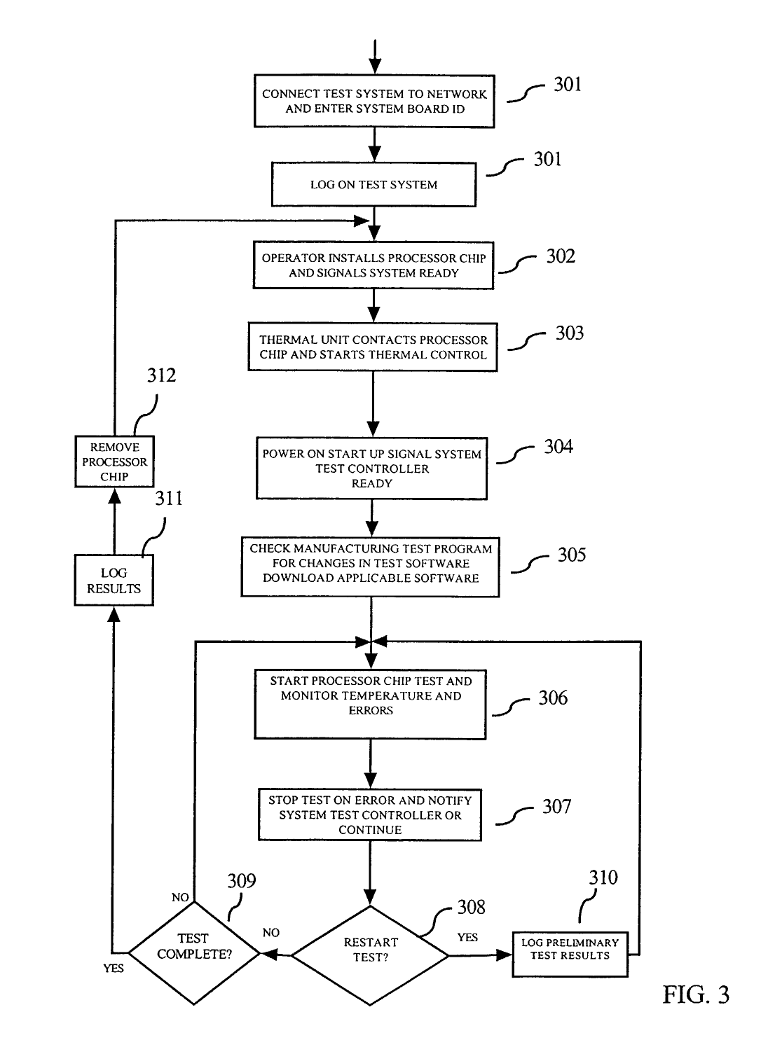

FIG. 3 shows method steps used in embodiments of the present invention. In step 300, a test station 103 is connected to the test system network coupled to a system test controller 102. In step 301, the test station 103 is logged into the network and identified by the system test controller 102. In step 302, an operator installs a processor chip 204 to test. Once installed and the test station 103 is enabled, the thermal unit 202 contacts the processor chip in step 303 and starts thermal control. To start thermal control, the thermal unit 202 heats or cools the processor chip 204 to ramp to a test set point temperature. In step 304, a power on sequence powers on the processor chip 204 and starts the internal power dissipation. As soon as the processor chip 204 reaches thermal equilibrium, the test system signals “ready” to the system test controller 102. In step 305, the system test controller 102 checks a master manufacturing test program to see if there are any changes in software routines for the processor chip under test and downloads to the test station 103 any applicable software. In step 306 the test is started and errors and temperature are monitored. The test is halted if an error condition is detected in step 307. Depending on the type of error and test conditions the system test controller 102 may continue to test or signal an operator to replace the chip and start a new test. A restart test condition is tested in step 308 if an error occurred. If the test is not restarted or no error occurred, a branch to step 309 is issued where test completion is checked. If the test is complete, results are logged in step 311, the chip is removed in step 312, and a branch back to step 302 is issued. If the test is restarted in step 308, a branch to step 310 saves preliminary results and a branch is issued to step 306 where the chip test is restarted.

Although the present invention and its advantages have been described in detail, it should be understood that various changes, substitutions and alterations can be made herein without departing from the spirit and scope of the invention as defined by the appended claims.

What is claimed is:

1. A semi-automatic test station for testing a processor chip comprising.
a fully functional system motherboard for said processor chip, said system motherboard further comprising:
a socket for said processor chip;
a network interface to a system test controller; and
a thermal unit operable to contact and to control the case temperature of said processor chip,
wherein said system motherboard provides a standard system electrical operating environment.

2. The test station in claim 1, wherein said test station is part of a network of test stations coupled to said system test controller within a standard network interface.

3. The test station in claim 1, wherein said test station has a storage device for storing application programs and executable test software downloaded by said system test controller

4. The test station in claim 3, wherein said storage device is memory on said system mother board.

5. The test station in claim 3, wherein said storage device is an input/output (I/O) storage device coupled to said system motherboard via an I/O connector

6. The test station in claim 3, wherein said executable test software comprises code for monitoring and reporting errors of said processor chip to said system test controller.

7. The test station in claim 3, wherein said executable test software controls which sequence of executable application programs are run for a given processor chip test.

8. The test station in claim 1, wherein tests of said processor chip may be started and stopped by manual operator controls.

9. The test station in claim 1, wherein test stations may be added under said system test controller as a network device limited only by the system test controller and the network configuration

10. The test station in claim 1, wherein said system test controller is a network server

11. The test station in claim 1, wherein said standard electrical operating environment comprises
a system motherboard power supply coupled to said system motherboard with cabling and decoupling as would be present if said system motherboard was installed in a customer level system, and further said system motherboard signal wiring and power distribution to said processor chip are the same design level as when said system motherboard is installed in a customer level system

12. The test station in claim 3, wherein said thermal unit is self contained and sends and receives processor chip case set point temperature data from said system test controller, said thermal unit coupled to said system motherboard via an input/output (I/O) interface connector.

13. The test station in claim 12, wherein said thermal unit sends and receives processor chip case set point temperature data under control of said executable test program.

14. A method for testing processor chips comprising
installing a processor chip in a fully functional system motherboard;
contacting said processor chip with a thermal unit operable to heat and cool said processor chip maintaining a set case temperature during test,
downloading, from a system test controller, application programs over a network connection and running said application programs on said system board using said processor chip under test; and
notifying said system test controller of operation errors resulting from running said application programs and logging results along with measured processor chip case temperature data,
wherein said system motherboard provides a standard system electrical operating environment.

15. The method in claim 14, wherein said test station is part of a network of test stations coupled to said system test controller within a standard network interface

16. The method in claim 14, wherein said test station has a storage device for storing application programs and executable test software downloaded by said system test controller.

17. The method in claim 16, wherein said storage device is memory on said system mother board.

18. The method in claim 16, wherein said storage device is an input/output (I/O) storage device coupled to said system motherboard via an I/O connector.

19. The method in claim 16, wherein said executable test software comprises code for monitoring and reporting errors of said processor chip to said system test controller

20. The method in claim 16, wherein said executable test software controls which sequence of executable application programs are run for a given processor chip test.

21. The method in claim 14, wherein tests of said processor chip may be started and stopped by manual operator controls.

22. The method in claim 14, wherein test stations may be added under said system test controller as a network device limited only by the system test controller and the network configuration

23. The method in claim 14, wherein said system test controller is a network server.

24. The method in claim 14, wherein said standard electrical operating environment comprises
a system motherboard power supply coupled to said system motherboard with cabling and decoupling as would be present if said system motherboard was installed in a customer level system, and further said system motherboard signal wiring and power distribution to said processor chip are the same design level as when said system motherboard is installed in a customer level system.

25. The method in claim 16, wherein said thermal unit is self contained and sends and receives processor chip case set point temperature data from said system test controller, said thermal unit coupled to said system motherboard via an input/output (I/O) interface connector.

26. The method in claim 25, wherein said thermal unit sends and receives processor chip case set point temperature data under control of said executable test program.
